(19) United States
(12) Patent Application Publication
(10) Pub. No.: US 2020/0224034 A1
(43) Pub. Date: Jul. 16, 2020

(54) FLUXING AGENTS FOR HYDROCARBON BINDERS

(71) Applicants: RHODIA OPERATIONS, Paris (FR); EUROVIA, Rueil Malmaison (FR)

(72) Inventors: Arnaud BOURDETTE, Chelles (FR); Frédéric DELFOSSE, Pessac (FR); Marie-Pierre LABEAU, Sevres (FR); Thomas LEBARBE, Audenge (FR); Hélène MARTIN, Chatillon (FR); Simon ROUSSEAU, Talence (FR)

(73) Assignees: RHODIA OPERATIONS, Paris (FR); EUROVIA, Rueil Malmaison (FR)

(21) Appl. No.: 16/628,935

(22) PCT Filed: Jul. 6, 2018
(86) PCT No.: PCT/FR2018/051694

§ 371 Date: Jan. 6, 2020

(30) Foreign Application Priority Data
Jul. 7, 2017 (FR) 1756441

(51) Int. Cl. C08L 95/00

(52) U.S. Cl. CPC C08L 95/005

(57) ABSTRACT

The invention relates to the use, as fluxing agent for bitumen compositions, of at least one compound having the formula (I)

R¹—C(O)O—R² (I)
where:
each of R¹ and R², which may be identical or different, is a linear or branched hydrocarbon chain which does not carry an unsaturated covalent bond, optionally interrupted by one or more oxygen atoms, and optionally carrying one or more hydroxyl functions.

The present invention relates to the field of fluxing agents for hydrocarbon binders, which can be used in particular in road applications. More precisely, the invention relates to the use, as fluxing agent, of a specific volatile compound of formula (I) as defined below in a composition comprising a hydrocarbon binder used for the production of a bitumen product based on mineral particles solidified by said composition comprising the hydrocarbon binder.

In so-called “bituminous” products, mineral particles are bonded by a hydrocarbon binder, in particular a bitumen. The hydrocarbon binders used in bituminous products of this type are highly viscous, typically viscoelastic products, which require, in order to be handled, to be heated, emulsified and/or added by so-called “fluxing” compounds which allow, among other things, their viscosity to be reduced. These fluxes may be of petroleum, petrochemical, carbochemical or even plant origin.

Common fluxes are fluxes of petroleum origin which include:
“petroleum fluxes” which are products resulting from the distillation of crude oil (light fraction(s)), which may have undergone a hydrotreatment operation. Examples include the fluxing agents marketed by Total (Greenflux® 2000, Greenflux® SD in particular).
“petrochemical fluxes” which are products from the distillation of crude oil (light fraction(s)), having undergone at least one thermal cracking and further distillation operation. One example is the flow agents marketed by VFT France (Adheflux®).

Such petroleum-based fluxes are quite satisfactory in terms of results. Indeed, when added to a hydrocarbon binder, they lower the viscosity at certain points while generally ensuring that the mechanical performance of the bituminous product based on this fluxed hydrocarbon binder is not substantially deteriorated and therefore makes them suitable for road use, in particular with sufficient increase in cohesion.

These petroleum-based fluxes are volatile products: after being incorporated into the hydrocarbon binder, where they ensure the desired reduction in viscosity, they evaporate, which causes the binder to recover its original characteristics. However, these released fluxes have many negative environmental impacts. Moreover, their use is dangerous and uncomfortable (harmful and unpleasant vapours and risk of fire).

Other volatile fluxing agents are fluxing agents of carbochemical origin which are products of coal pyrolysis, having undergone at least one distillation operation, which have the major disadvantage of being recognized as carcinogenic.

To replace the above-mentioned volatile fluxing agents, fluxing agents of natural non-fossil origin (plant or animal origin) have been proposed, which prevent the release of harmful volatile organic compounds. A flux of natural non-fossil origin is a natural non-fossil oil, a derivative thereof such as fatty acid esters, or a mixture of two or more such oils and/or oil derivatives. In particular, plant oils such as sunflower, rapeseed, peanut, copra, linseed, palm, soya, olive, castor, maize, pumpkin, grape seed, jojoba, sesame, walnut, hazelnut, Chinese wood, tall oil, and derivatives and mixtures thereof. These oils contain unsaturated fatty acids, mainly at least C₁₆ unsaturated fatty acids. Such fluxes are for example described in applications FR 2 910 477, EP 0 900 822, FR 2 721 043 and FR 2 891 838.

With non-volatile fluxes of the type mentioned above, the increase in consistency of the binder in the final product (after spreading or coating) is not by evaporation, unlike the case of volatile fluxes, but by cross-linking, typically as a result of radical reactions, with unsaturated fatty chains reacting in the presence of oxygen in the air. These reactions, which can be catalysed by the addition of drying agents such as metal salts, include the formation of —O—O— peroxide bridges on the unsaturated chains. These bridges are unstable and lead to the formation of free radicals which themselves will react with other unsaturations of other chains. This flux cross-linking technique is therefore only applicable to unsaturated compounds. The flux is selected on the basis of the iodine value, which characterizes the rate of unsaturation of a compound and therefore its ability to react by drying.

Although they have less impact on the environment and on worker health and safety, natural non-fossil fluxes are less satisfactory than petroleum-based fluxes in terms of results. Indeed, the results of in terms of increased cohesion are less good. They most often underperform in bad weather, high heat or excessively dense traffic, problems of bleeding, linked in particular to a bad adhesion of the fluxed hydrocarbon binder on the solid mineral particles.

For example, bitumen products based on bitumen fluxed with naturally occurring non-fossil fluxes are currently considered unsuitable for moderate to heavy traffic and climatic variations.

One purpose of the invention is to provide a solution:
for lowering the viscosity of a hydrocarbon binder
providing a hydrocarbon binder with a good wettability with respect to solid mineral particles
without presenting the above-mentioned disadvantages, in particular having satisfactory cohesion-increasing results that are superior to those obtained with the non-fossil fluxes of natural origin described above.

For this purpose, it is proposed according to the present invention to use as fluxes, particular compounds, the inventors of which have now discovered, in the course of the work leading to the present invention, (1) that they behave as advantageous volatile fluxes which, once incorporated into compositions comprising a hydrocarbon binder and prior to their evaporation, reduce the viscosity of the hydrocarbon binder, which can therefore be processed more easily, but without the disadvantages of the usual volatile fluxes in terms of environmental impact and worker toxicity; and (2) that they also provide the composition with satisfactory wettability with respect to solid mineral particles, of the same order as those of the best fluxing agents currently in use, such as Greenflux® SD, which, in particular, allows proper adhesion to solid mineral particles.

More precisely, the subject matter of the invention is the use, as fluxing agent, of at least one compound corresponding to formula (I), preferably having a molecular weight of 140 g/mol to 270 g/mol, or of a mixture comprising at least one such compound of formula (I)

R¹—C(O)—O—R² (I)
where:
each of R¹ and R², which may be identical or different, is a linear or branched hydrocarbon chain which does not carry an unsaturated covalent bond, optionally interrupted by one or more oxygen atoms, and optionally carrying one or more hydroxyl functions
provided that, in the case of a mixture further comprising one or more unsaturated compounds of the formula (II)R—C(O)—O—R′ (II)
where:
each of R and R′, identical or different, is a hydrocarbon chain comprising at least one unsaturated covalent bond, for example a C═C double bond, linear or branched,
the mass ratio (II)/(I+II), defined as the ratio of the total mass of the unsaturated compounds of formula (II) to the sum of the total mass of the compounds of formula (I) and the total mass of the unsaturated compounds of formula (II), is less than 15% by mass, preferably less than 10% by mass;

According to the invention, a single compound of formula (I) or a mixture of several compounds of formula (I) may be used.

The compounds of formula (I), alone or in mixtures, have proved to be compounds that the inventors' work has shown that they are volatile within a bitumen-type hydrocarbon binder and that they therefore provide an effect similar to petroleum-based fluxes, but without the problems of their environmental impact and toxicity to workers.

Moreover, the compounds of formula (I), before their volatilization, ensure not only a decrease in the viscosity of the binder at certain points, but also a wettability of the solid mineral particles by the binder of the same order as that of the best fluxing agents currently used.

A compound of formula (I) according to the invention is typically employed in a composition comprising a hydrocarbon binder for the preparation of a bitumen product based on solid mineral particles in contact with said hydrocarbon binder. The compound of formula (I) as employed according to the invention can be used not only to reduce the viscosity of the hydrocarbon binder, but also, more specifically, to ensure good wettability of the solid mineral particles by the composition comprising the binder. For this purpose, the compound of formula (I) is preferably present in the bitumen composition during all or part of the period of time when the composition is brought into contact with the solid mineral particles. In practice, the compound of formula (I) can in particular be added to the composition comprising the hydrocarbon binder according to one and/or other of the following 3 compatible variants:
variant 1: the compound of formula (I) is added at least partially (if variant 2 and/or 3 is also used), or even completely (if variant 2 and/or 3 is not used), to the composition comprising the hydrocarbon binder, then the composition comprising the compound of formula (I) is brought into contact with the solid mineral particles before complete evaporation of the compound of formula (I) from the composition (in other words, said compound of formula (I) is still present at least partly in the composition when it is brought into contact with the solid mineral particles, preferably in a sufficient amount in the composition to act as a fluxing agent); and/or
variant 2: the compound of formula (I) is added at least partly (if variant 1 and/or 3 is also used), or even completely (if variant 1 and/or 3 is not used), at the same time as the solid mineral particles to the composition comprising the hydrocarbon binder and/or
variant 3: the compound of formula (I) is added at least partly (if variant 1 and/or 2 is also used), or even wholly (if variant 1 and/or 2 is not used), to a premix containing the solid mineral particles and the composition comprising the hydrocarbon binder

It should be noted that when variant 2 and/or 3 is employed, it may well be envisaged to use, in a preliminary step (SO), compounds of formula (I) as fluxes in the binder-based composition (for example to manufacture a bitumen emulsion type composition), and then to allow the compounds of formula (I) employed to evaporate completely. In this case, in order to implement variant 2 or 3, compounds of formula (I), identical or different from those used in the preliminary step (SO), will be introduced together and/or after mixing the composition with the solid mineral particles.

The compounds of formula (I) according to the invention make it possible to lower the viscosity of the hydrocarbon binder into which they are added while ensuring good wettability of the solid mineral particles by the composition comprising the binder.

Advantageously, the compounds of formula (I) according to the invention also make it possible to obtain a high-performance binder after stabilization (these performances are seen through the results of penetrability, ball-ring temperature).

Preferably, the compounds of formula (I) according to the invention allow a decrease in the viscosity of the hydrocarbon binder during its use without affecting its performance, in particular the results of increase in cohesion, and its capacity to wet solid mineral particles.

The following definitions will be adopted throughout the present description:

Hydrocarbon binder:

“Hydrocarbon binder” means any hydrocarbon binder of fossil or plant origin that can be used for the production of so-called “bituminous” products, this hydrocarbon binder which may or may not typically be a bitumen, and may be pure or modified, in particular by the addition of polymer(s).

The binder can be a soft to hard binder, advantageously of a grade ranging from 10/20 to 160/220.

The hydrocarbon binder can be a bitumen, pure or polymer modified.

The bitumen-modifying “polymer” referred to here may be selected from natural or synthetic polymers. For example, it is a polymer from the family of elastomers, synthetic or natural, and in an indicative and non-limiting manner:
statistical, multiblock or star copolymers of styrene and butadiene or isoprene in any proportions (in particular styrene-butadiene-styrene (SBS), styrene-butadiene (SB, SBR for styrene-butadiene rubber), styrene-isoprene-styrene (SIS) block copolymers) or copolymers of the same chemical family (isoprene, natural rubber, etc.), optionally cross-linked in situ,
copolymers of vinyl acetate and ethylene in any proportion,
copolymers of ethylene and esters of acrylic acid, methacrylic acid or maleic anhydride, copolymers and terpolymers of ethylene and glycidyl methacrylate, and polyolefins.

The bitumen-modifying polymer can be chosen from recovered polymers, for example “rubber powders” or other rubber-based compositions reduced to pieces or powder, for example obtained from used tyres or other polymer-based waste (cables, packaging, agricultural, etc.) or any other polymer commonly used for the modification of bitumens such as those cited in the Technical Guide written by the World Road Association (PIARC) and published by the Laboratoire central des ponts et chaussées “Use of Modified Bituminous binders, Special Bitumens and Bitumens with Additives in Road Pavements” (Paris, LCPC, 1999), as well as any mixture in any proportion of these polymers.

The composition comprising the binder may be in the form of an anhydrous binder or in the form of an emulsion (typically bitumen emulsion).

25

The emulsion is a dispersion of the binder (bitumen, synthetic binder or plant binder) in a continuous phase, typically an aqueous phase, for example water. A surfactant can be added to the emulsion to stabilize it.

During the manufacture of an emulsion, the binder is dispersed in fine droplets in the water, for example by mechanical action. The addition of a surfactant forms a protective film around the droplets, preventing them from clumping and allowing the mixture to remain stable and stored for some time. The amount and type of surfactant added to the mixture determines the storage stability of the emulsion and influences the curing time at the time of application. The surfactant can be positively charged, negatively charged, amphoteric or non-ionic.

The surfactant is advantageously of petroleum, plant, animal origin and mixtures thereof (for example the surfactant can be of plant and petroleum origin). The surfactant can be an alkaline soap of fatty acids: sodium or potassium salts of an organic acid (resin for example). The emulsion is then anionic. The surfactant may be an acid soap, which is usually obtained by the action of hydrochloric acid on one or two amines. The emulsion is then cationic. Among the surfactants relevant to road applications are: surfactants marketed by Akzo NOBEL (Redicote® E9, Redicote® EM 44, Redicote® EM 76), surfactants marketed by CECA (Dinoram® S, Polyram® S, Polyram® L 80), surfactants marketed by MeadWestvaco (Indulin® R33, Indulin® R66, Indulin® W5). One or more of these surfactants may be used alone or in mixtures.

The emulsion may contain synthetic or natural latex. Latex means a dispersion of polymers (polyisoprene, SBS, SB, SBR, acrylic polymers, etc,) optionally cross-linked in aqueous phase. This latex is incorporated into the aqueous phase before emulsification or in-line during the manufacture of the emulsion or after manufacture of the emulsion.

The composition comprising the binder may be in whole or in part in the form of a foam typically obtained by a process of injecting a amount of water, and possibly air, into the binder inlet, the water being pure or may comprise additives for modifying the adhesive or even the rheological properties of the binder.

Whatever its form, the composition comprising the binder, typically within the binder, additives commonly used in the road field, such as compositions based on rubber reduced to powder (“rubber powders”), plant or petrochemical waxes, adhesion dopes.

Solid Mineral Particles

In the present description, “solid mineral particles” means any solid particles that can be used for the production of bituminous products, in particular for road construction, including natural mineral aggregates (gravel, sand, fines) from quarries or gravel pits, recycling products such as asphalt aggregates resulting from the recycling of materials recovered during road repairs and coating plant surpluses, manufacturing scrap, shingles (from recycling of roofing membranes), aggregates from recycling of road materials including concrete, slag in particular slag, shale in particular bauxite or corundum, rubber powder from recycling of tyres in particular, artificial aggregates of any origin and coming for example from municipal solid waste incineration (MSWI) fly ash, as well as their mixtures in any proportion.

Natural mineral aggregates include:
elements smaller than 0.063 mm (filler or fines)
sand with elements between 0.063 mm and 2 mm;
chippings, the elements of which have dimensions
   between 2 mm and 6 mm;
   greater than 6 mm;

The size of mineral aggregates is measured by the tests described in NF EN 933-2 (May 1996 version).

“Asphalt aggregates” means asphalt mixes (a mixture of aggregates and bituminous binders) resulting from the milling of asphalt layers, the crushing of slabs extracted from pavements into asphalt mixes, pieces of asphalt slabs, asphalt waste or surplus asphalt production (surplus production is asphalt or partially asphalt materials in plant resulting from the transitional phases of manufacture). These elements and other recycling products can reach dimensions up to 31.5 mm.

“Solid mineral particles” are also referred to as “mineral fraction 0/D”. This mineral fraction 0/D can be separated into two grain sizes: the mineral fraction 0/d and the mineral fraction d/D.

The finest elements (the mineral fraction 0/d) will be those in the range between 0 and a maximum diameter that can be set between 2 and 6 mm (from 0/2 to 0/6), advantageously between 2 and 4 mm. The remaining elements (minimum diameter greater than 2, 3, 4, 5 or 6 mm; and approximately up to 31.5 mm) make up the mineral fraction d/D.

Compound of formula (I)

The invention uses a compound, or mixture of compounds, preferably having a molecular weight of 140 g/mol to 270 g/mol, having the formula (I)

R¹—C(O)—O—R² (I)
where:
each of R¹ and R², which may be identical or different, is a linear or branched hydrocarbon chain not comprising unsaturated covalent bonds, optionally interrupted by one or more oxygen atoms, and optionally carrying one or more hydroxyl functions.

It should be noted that according to a variant of the invention, the compound of formula (I) may be in the form of a mixture comprising different compounds of formula (I). In the application, unless the presence of two or more compounds is explicitly mentioned, “one” compound may refer to a single compound of formula (I) or to a mixture or combination of several compounds of formula (I).

The compounds of formula (I) also preferably have a molecular weight of 140 g/mol to 270 g/mol. For example, the molecular weight may be greater than or equal to 150 g/mol, in particular greater than or equal to 160 g/mol or even 170 g/mol. In addition, the molecular weight typically remains below 260 g/mol, for example less than or equal to 250 g/mol.

The compounds of formula (I) are found to be volatile in most hydrocarbon binders and in particular in bitumen, i.e. over time they will evaporate from the bitumen compositions containing them.

In the compounds of formula (I) used according to the invention, the total number of carbon atoms is preferably between 5 and 17. According to an embodiment, the total number of carbon atoms is greater than or equal to 6, or greater than or equal to 7, for example greater than or equal to 8. In addition, it is generally preferred that the total number of carbon atoms be less than or equal to 16, for example less than or equal to 15. The total number of carbon atoms can for example be between 10 and 17, for example between 13 and 15 or between 13 and 17 or 14 or 10.

The groups R¹ and R², identical or different, advantageously represent a C1-C16, typically C1-C15, linear or branched, cyclic or non-cyclic (and generally non-cyclic) alkyl group.

In an embodiment, one of the groups R¹ or R² contains from 1 to 5 carbon atoms, and advantageously 1, 2, 3, 4 or 5 carbon atoms. This group R¹ or R² can be linear or branched. In this case, this group R¹ or R² is typically not interrupted by an oxygen atom. In this case, this group R¹ or R² is typically not substituted by a hydroxyl function.

This group R¹ or R² can be selected in particular from methyl, ethyl, n-propyl, isopropyl, n-butyl, isobutyl, n-pentyl, isoamyl, in particular methyl, ethyl or isopropyl.

In this embodiment, the other group R¹ or R² generally contains 8 to 15 carbon atoms, in particular between 9 and 14, in particular 11 carbon atoms. The other group R¹ or R² may be linear or branched. In this case, the other group R¹ or R² may be interrupted by at least one oxygen atom. In this case, the other group R¹ or R² may be substituted by at least one hydroxyl function.

According to a particular embodiment, at least one of the groups R¹ or R² carries at least one hydroxyl group —OH. Among the useful compounds according to the invention in which R² carries a hydroxyl group, particular mention may be made of 2,2,4-trimethyl-1,3-pentanediol monoisobutyrate (Texanol®).

As examples of compounds of formula (I), particular mention may be made of methyl laurate, ethyl laurate, isopropyl laurate, a mixture of methyl laurate and methyl myristate, methyl cocoate, ethyl cocoate, isopropyl cocoate, methyl myristate, ethyl myristate, isopropyl myristate, Texanol® or 2-ethyl hexyl acetate.

The compounds of formula (I) useful according to the invention, which are volatile by nature, may be used in admixture with less volatile compounds. In the case of a mixture further comprising one or more unsaturated compounds of formula (II)

R—C(O)—O—R′ (II)
where:
each of R and R′, identical or different, is a linear or branched unsaturated hydrocarbon chain comprising at least one C═C double bond,

the mass ratio (II)/(I+II), defined as the ratio of the total mass of the unsaturated compounds of formula (II) to the sum of the total mass of the compounds of formula (I) and the total mass of the unsaturated compounds of formula (II), is less than 15% by mass. Preferably, this ratio is less than 10% by mass, or even less than 5% by mass or less than 2% by mass.

In an embodiment, the compounds of formula (I) useful according to the invention are employed in the form of a mixture not comprising a compound of formula (II).

In other words, according to the invention, if compounds carrying unsaturated groups are used in conjunction with the compounds of formula (I), such as drying fluxes for example, these are in a minority in mass, or even are absent.

Typically, when the compound of formula (I) is employed in the form of a mixture, said compound has an iodine value according to ISO 3961:2013 of less than 50 g I₂/100 g. Advantageously this iodine value is less than 30 g I₂/100 g, advantageously less than 10 g I₂/100 g, more advantageously less than 5 g I₂/100 g, even more advantageously less than 3.5 g I₂/100 g. The iodine value of a mixture is the mass of diiodine (I₂) (expressed in g per 100 g of mixture) capable of binding to the unsaturated carbon-carbon covalent bonds present in the mixture and which generally reflects the number of unsaturated C═C bonds in the mixture.

Bituminous Products “Bituminous product” in the present invention means a product based on hydrocarbon binder and solid mineral particles. Particular mention may be made of coatings, emulsion mixes, storable mixes, hot mixes, warm mixes with controlled workability, which are described in more detail below.

According to the invention, the bituminous product is advantageously:
A surface dressing;
An emulsion asphalt concrete;
A cold-mix bituminous material;
Hot or warm asphalt;
A storable asphalt mix.

The bituminous products can contain high contents (ranging from 0% to 100% by weight, advantageously from 20% to 50% by weight, based on the total weight) of recycling products (asphalt product aggregates, asphalt aggregates).

Coatings

Surface dressing, in the sense of the present description, means a layer consisting of superimposed layers of a hydrocarbon binder and solid mineral particles. It is typically obtained by pulverizing a hydrocarbon binder and then spreading solid mineral particles in one or more layers over this binder. The whole is then compacted. A surface dressing requires not only a binder that is fluid enough to be sprayed, but also a binder that allows the solid mineral particles to adhere well to the substrate.

Thus, the flux added to the binder must allow it to soften without penalizing the wetting of the solid mineral particles by the binder. Furthermore, the flux must be able to soften the binder during spraying, but once sprayed the binder must harden quickly to also meet the criterion of increased cohesion. If the binder does not properly wet the solid mineral particles, the adhesion of this binder to these particles will be unsatisfactory or even unacceptable.

The affinity between the binder and the solid mineral particles is determined by the wettability of the solid mineral particles by the binder, which is assessed by means of the binder aggregate adhesivity determination test by measuring the Vialit cohesion (NF EN 12272-3, 2003-07-01).

It was discovered that the compounds of formula (I) made it possible to effectively flux the binder, with a satisfactory increase in cohesion, without penalizing the affinity between binder and solid mineral particles.

The compound(s) of formula (I) is/are advantageously added in their entirety to the composition comprising the hydrocarbon binder, then the composition comprising the hydrocarbon binder and the one or more compounds of formula (I) is sprayed onto the solid mineral particles before complete evaporation of the compound of formula (I) from the composition. In other words, said compound of formula (I) is still present at least in part when the fluxed binder and the solid mineral particles are brought into contact, preferably in a sufficient amount in the composition to allow good adhesion of the binder to the solid mineral particles.

The solid mineral particles used in a dressing advantageously belong to the following granular classes (d/D): 4/6.3, 6.3/10, 10/14.

The total content of hydrocarbon binder in a dressing will be adapted according to the structure of the dressing (single or two-layer, type of gravel), the nature of the binder and the size of the aggregates, following for example the recommendations of the document “Wearing courses—Technical guide, May 1995 [in French]”.

The hydrocarbon binder used in the manufacture of a dressing may be pure bitumen or polymer-modified bitumen, as described above.

The hydrocarbon binder used for the manufacture of a dressing may be in the form of an anhydrous binder or in the form of a binder emulsion.

In an embodiment, the hydrocarbon binder is used in the form of an anhydrous binder during the manufacture of the dressing.

In this embodiment, the hydrocarbon binder advantageously comprises, based on the total weight of the hydrocarbon binder, from 3% to 18% by weight of said compound of formula (I).

In this embodiment, the dressing is advantageously applied at a temperature less than or equal to 200° C., for example from 120° C. to 180° C. or from 130° C. to 160° C.

In another embodiment, the hydrocarbon binder is a binder emulsion.

In this embodiment, the hydrocarbon binder advantageously comprises, based on the total weight of the hydrocarbon binder, 0.1 to 10% by weight of said compound of formula (I), more advantageously 0.5 to 8% by weight, still more advantageously 1 to 6% by weight.

In this embodiment, the dressing is advantageously applied at a temperature less than or equal to 40° C., for example from 5° C. to 40° C. or from 15° C. to 35° C.

Bituminous Concrete Emulsion (BCE)

Bituminous concrete emulsions, also called asphalt emulsions, are hydrocarbon asphalt mixes made cold from aggregates and a hydrocarbon binder emulsion. The aggregates can be used without prior drying and heating or can be partially pre-coated with hot water. It may sometimes be necessary to reheat the product after manufacture, during processing.

This technique, known as the “cold” technique, has the important environmental advantage of not producing fumes, which reduces the nuisance for workers and local residents. Bituminous concrete emulsions consist of a mixture of solid mineral particles including aggregates, bitumen emulsion (optionally modified), and additives.

However, the quality of the dressing can be poor, with the observation of a stripping phenomenon: poor distribution of the bitumen film over the entire granular fraction, all the more so as the fluxing or fluidizing content is high. The more fines there are in the granular fraction, the worse the distribution of the binder on the granular fraction (mainly on the larger elements) will be.

To remedy or limit these problems of loss of compactability and poor distribution of the bitumen film over the entire granular fraction, the step of mixing the granular fractions and the binder, optionally the fluxing agent, can be sequenced. These sequenced processes involve more steps and are therefore less economical.

It has now been discovered that compounds of formula (I) are effective in fluxing bituminous concrete emulsions. Compounds of formula (I) also assist compaction. The invention may also make it possible to dispense with the implementation of sequenced and/or reheating processes.

The compound(s) of formula (I) is/are advantageously added to the composition comprising the hydrocarbon binder according to one and/or other of the 3 variants described previously on pages 4 and 5, and thus before and/or during and/or after bringing the binder and the solid mineral particles into contact. The compound(s) of formula (I) is/are introduced at the latest before the bituminous concrete emulsion is laid, and are present at least in part in the composition comprising the binder and the solid mineral particles to allow good adhesion.

In an embodiment adapted to bituminous concretes, the compound(s) of formula (I) is/are introduced into the composition comprising the binder emulsion, then said composition is brought into contact with solid mineral particles (variant 1).

In another embodiment adapted to bituminous concretes, the compound(s) of formula (I) is/are introduced at least partly at the same time as the solid mineral particles with a composition comprising the hydrocarbon binder (variant 2).

In another embodiment adapted to bituminous concretes, part or all of the compound(s) of formula (I) is introduced into a premix based on binder emulsion and solid mineral particles (variant 3). The resulting composition still includes a sufficient amount of compound of formula (I) for the application of the bituminous concrete emulsion.

The solid mineral particles for bituminous concrete emulsions include advantageously:
elements smaller than 0.063 mm (filler or fines)
sand with elements between 0.063 mm and 2 mm;
chippings, the elements of which have dimensions ranging from 2 mm to 6, 10 or 14 mm.

The hydrocarbon binder used for the synthesis of bituminous concrete emulsions is in the form of a binder emulsion. The total hydrocarbon binder content in said emulsion is typically 2 to 8 wt % (percentage by weight), advantageously 3 to 7 wt %, more advantageously 3.5 to 5.5 wt %, based on the weight of the solid mineral particles. This binder content corresponds to the amount of binder introduced as such (filler binder) plus the amount of binder recovered from the asphalt aggregates forming part of the solid mineral fraction.

The hydrocarbon binder in an emulsion used for making a bituminous concrete emulsion advantageously comprises, based on the total weight of the hydrocarbon binder, 1 to 25% by weight of said compound of formula (I), more advantageously 2 to 15% by weight, even more advantageously 2 to 10% by weight, even more advantageously 3 to 10% by weight. These contents are calculated whether the compound of formula (I) is actually added to the hydrocarbon binder before being brought into contact with solid mineral particles or whether it is added to the composition comprising the binder and the solid mineral particles.

The bituminous concrete emulsions obtained according to the invention can be used for the manufacture of storable asphalt mixes.

In this embodiment, the hydrocarbon binder advantageously comprises, based on the total weight of the hydrocarbon binder, 10 to 30% by weight of said compound of formula (I), more advantageously 15 to 25% by weight, even more advantageously 17 to 22% by weight.

Cold-Mix Bituminous Materials (CMBM)

Cold-mix bituminous materials are surface layer asphalts consisting of undried aggregates coated with bitumen emulsion and continuously poured in place by means of specific equipment.

After application and breaking of the emulsion, this very thin cold-mix dressing (generally 6 to 13 mm thick per layer) must reach its final consistency (increase in cohesion) very quickly. The two essential parameters governing the formulation, manufacture and application of cold-mix bituminous materials are:
the workability of the aggregate/emulsion mixture: optimization of the proportions of the different constituents (water, additives, emulsion formulation) to obtain a sufficient lead time and thus allow the mixing of the aggregates with the emulsion in the mixer.
the kinetics of “increase in cohesion”: the cold-mix bituminous material, after application on the pavement, must acquire an increase in cohesion as quickly as possible for opening to traffic. For curing temperatures ranging from 7 to 40 ° C., a 30-minute delay is considered relevant for the person skilled in the art to meet the strictest specifications.

It was discovered that the compounds of formula (I) made it possible to effectively flux cold-mix bituminous materials. In particular, the compounds of formula (I) make it possible to improve the cohesion kinetics of the cold-mix bituminous material.

For a cold-mix bituminous material, the initially separated bitumen droplets give the system a fluid character and make it easy to place using the specific machines for cold-mix bituminous materials. The system is then viscous. The characteristic time during which this state lasts is called the handling time. In a second step, the bitumen droplets gradually coalesce. When all the bitumen droplets are pooled, the emulsion is considered to have broken (break time). The system is then viscoelastic. The system then tends to contract so as to reduce the contact surface between the water and the bitumen (cohesion time). This process follows a kinetics which will depend on the electrostatic repulsions between droplets and therefore on the nature of the bitumen and the emulsifier. The kinetics of the coalescence reaction between the bitumen droplets will condition the speed of the increase in cohesion of the cold-mix bituminous material, which may or may not result in the material's sensitivity to the curing conditions at a young age.

The compounds of formula (I) advantageously facilitate the coalescence of bitumen droplets.

In an embodiment adapted to cold-mix bituminous materials, the compound(s) of formula (I) is/are introduced into the composition comprising the binder emulsion, then said composition is brought into contact with solid mineral particles (variant 1).

In a first variant of the preceding embodiment, the compound(s) of formula (I) is/are introduced into the hydrocarbon binder and then the hydrocarbon binder is emulsified in a continuous aqueous phase.

In a second variant of the preceding embodiment, the compound(s) of formula (I) is/are introduced into the hydrocarbon binder already in emulsion.

In another embodiment adapted to cold-mix bituminous materials, the compound(s) of formula (I) is/are added at the same time as the solid mineral particles to the composition comprising the hydrocarbon binder emulsion (variant 2). It is possible to premix the compound(s) of formula (I) and the solid mineral particles.

In another embodiment, the two previous embodiments are combined and therefore:
a part of the compound(s) of formula (I) is introduced into the composition comprising the binder emulsion, according to the first or second variant, then said composition is brought into contact with solid mineral particles, and
another part of the compound(s) of formula (I) is added at the same time as the solid mineral particles to the composition comprising the hydrocarbon binder emulsion and the already introduced part of the compound(s) of formula (I).

In another embodiment adapted to cold-mix bituminous materials, part or all of the compound(s) of formula (I) is introduced into a premix based on binder emulsion and solid mineral particles (variant 3), before the emulsion breaks.

The solid mineral particles used for cold-mix bituminous materials advantageously include:
elements smaller than 0.063 mm (filler or fines)
sand with elements between 0.063 mm and 2 mm;
   chippings, the elements of which have dimensions ranging from 2 mm to 6, 10 or 14 mm.

The hydrocarbon binder used for the manufacture of cold-mix bituminous materials is in the form of a binder emulsion.

In this emulsion, the binder content advantageously varies from 50 to 75% by weight of binder, based on the total weight of the emulsion, more advantageously from 55 to 70% by weight, even more advantageously from 60 to 65% by weight.

The hydrocarbon binder suitable for cold-mix bituminous materials advantageously comprises, based on the total weight of the hydrocarbon binder, 0.1 to 6% by weight of said compound of formula (I), more advantageously 0.1 to 3% by weight of said compound of formula (I). In a variant, the hydrocarbon binder comprises less than 2% by weight of said compound of formula (I), advantageously less than 1.5% by weight, even more advantageously 0.1 to 1% by weight of said compound of formula (I).

Hot or Warm Hydrocarbon Asphalts

Hot-mix hydrocarbon asphalt is obtained by hot-mixing aggregates and a binder. This binder can be a pure or modified bitumen (for example addition of polymer(s), petroleum-based or plant-based fluxes), a pure or modified plant-based binder or a synthetic binder of petroleum origin. The aggregates are heated, as a rule, to a temperature above 100° C.

Warm hydrocarbon asphalt mixes are asphalt mixes that are laid at temperatures about 30 to 50° C. lower than those used for hot hydrocarbon asphalt mixes.

It was discovered that the compounds of formula (I) were effective in fluxing hot or warm hydrocarbon asphalt mixes, with a satisfactory increase in cohesion and good wettability of solid mineral particles.

The compound(s) of formula (I) is/are advantageously added to the composition comprising the hydrocarbon binder according to one and/or other of the 3 variants described previously on pages 4 and 5, and thus before and/or during and/or after bringing the binder and the solid mineral particles into contact. The compound(s) of formula (I) is/are introduced at the latest before hot or warm hydrocarbon mixes are laid, and are present at least partly in the composition comprising the binder and the solid mineral particles to allow good adhesion.

In a suitable embodiment, the compound(s) of formula (I) is/are introduced into the composition comprising the binder, then said composition is brought into contact with solid mineral particles (variant 1).

The solid mineral particles are as previously defined and advantageously include:
elements smaller than 0.063 mm (filler or fines)
sand with elements between 0.063 mm and 2 mm;
   chippings, the elements of which have dimensions ranging from 2 mm to 6, 10 or 14 mm.

The hydrocarbon binder is in an anhydrous form.

The total hydrocarbon binder content is 3 to 7 wt % (percentage by weight), preferably 3.5 to 6 wt % based on the weight of solid mineral particles.

This binder content corresponds to the amount of binder introduced as such (filler binder) plus the amount of binder recovered from the asphalt aggregates forming part of the solid mineral fraction.

For hot or warm hydrocarbon asphalt mixes, the hydrocarbon binder advantageously comprises, based on the total weight of the hydrocarbon binder, 1 to 30% by weight of said compound of formula (I).

The flux content is adjusted according to the time between manufacture and processing.

When hot or warm hydrocarbon asphalt mixes are used rapidly after manufacture, for example for the manufacture of wearing courses, the hydrocarbon binder advantageously comprises, based on the total weight of the hydrocarbon binder, 0.1 to 6% by weight of said compound of formula (I).

These hot or warm hydrocarbon mixes can be used for the manufacture of storable asphalt mixes.

In this embodiment, the hydrocarbon binder advantageously comprises, based on the total weight of the hydrocarbon binder, 15 to 30% by weight of said compound of formula (I), more advantageously 15 to 25% by weight, even more advantageously 17 to 22% by weight.

### EXAMPLES

### Description of Test Methods:

Stabilization of fluxed binders:
   Anhydrous binders: This is a method of obtaining a thin layer of binder. Stabilization is carried out according to NF EN 13074 1.2 (April 2011) by leaving the bitumen fluxed for 24 hours at laboratory temperature, then transferred to a ventilated oven for 24 hours at 50° C., and finally 24 hours at 80° C. to allow the flux to evaporate.
STV pseudo-viscosity:
   For anhydrous binders: This is a method of measuring the viscosity of a fluxed bitumen by determining the flow time of the product at 40° C. or 50° C. through a 10 mm orifice. STV pseudo-viscosity is measured according to NF EN 12846-2 (April 2011).
Penetrability: Penetrability is the consistency expressed as the depth, in tenths of a millimetre, corresponding to the vertical penetration of a reference needle into a test sample of the material, under prescribed conditions of temperature, load and time of application of the load. The penetrability test is carried out according to standard NF EN 1426 (June 2007). In the examples, the measurements were taken at 25° C., for a load of 100 g and a duration of 5 s. Penetrability can be measured from a fluxed bitumen, a stabilized binder obtained from a fluxed bitumen or a
Ball-ring temperature: This is the temperature at which the binder reaches a precise consistency under the reference conditions of the test. Two horizontal discs of bitumen, moulded in shouldered brass rings, are heated in a stirred liquid (water) bath with a controlled rate of temperature rise (5° C./min, initial bath temperature of (5±1) ° C.), while each supports a steel ball. The softening point noted will correspond to the average temperature at which the two discs soften sufficiently to allow each ball, wrapped with bituminous binder, to descend from a height of (25.0±0.4) mm. The measurement is carried out in accordance with standard NF EN 1427 (June 2007). The ball-ring temperature can be measured from a fluxed bitumen, a stabilized binder obtained from a fluxed bitumen or a stabilized binder obtained from a bitumen emulsion.
Loss of mass after stabilization: The loss of mass after stabilization is measured as the difference in mass between the binder deposited at the beginning of the stabilization procedure and the binder mass actually measured after the stabilization step (standard NF EN 13074 1.2, April 2011).
Evaporation curves (thermobalance): This is a measure of the loss of mass of a fluxed bitumen as a function of time at a fixed temperature of 85° C. The test is carried out using a thermobalance and allows the evaporation kinetics of a flux to be evaluated.
Adhesivity: This is a method for determining the binder-aggregate adhesivity and the influence of additives on the characteristics of this adhesivity (Standard NF EN 12272-3, July 2003). The required amount of binder is heated to the spreading temperature and then applied evenly to a steel plate. The test is carried out at (5±1° C.). One hundred graded chippings are distributed over the binder and then rolled. The prepared plate is turned over and placed on a three-point support. A steel ball falls on the plate from a height of 500 mm, three times in 10 s.
The compactability of an emulsion asphalt concrete is determined by the gyratory shear press compaction test (NF P 98-252—June 1999): Compaction is obtained by kneading under low static compression a cylinder of hydrocarbon mix contained in a mould limited by pellets and maintained at a fixed temperature. Compaction is achieved by a combination of gyratory shear and an axial resultant force applied by a mechanical head. This method makes it possible to determine the evolution of the percentage of voids in the specimen as a function of the number of gyrations.
BCE modulus (NF EN 12697-26 Annex C—June 2012): Prior to the measurement of the stiffness modulus, emulsion asphalt concrete specimens are prepared by press compaction at a voids content value equivalent to the voids content measured according to the Duriez modality 2 test by removing 2%. The specimens are then cured at 35° C. and 20% humidity for 14 days. The stiffness modulus is then measured at 14 days by indirect tension to cylindrical specimens conditioned at 10° C. (IT-CY). The rise time, measured from the start of the loading pulse and which is the time required for the application of the load to move from the initial contact loading to the maximum value, must be 124±4 ms.
BCE handling: This test is carried out 4 hours after the BCE has been manufactured with a NYNAS workability meter. It consists in measuring the force required by a mobile arm to move at constant speed about 10 kg of asphalt contained in a mould provided for this purpose. The workability of the asphalt is sufficient if the force is less than about 200 newtons.
Duriez test, modality 1 (NF P 98-251-4, DATE): The purpose of this test method is to determine, for two compaction modalities, the percentage of voids and the water resistance, at 18° C., of a cold hydrocarbon mixture with bitumen emulsion from the ratio of the compressive strengths with and without immersion of the specimens. According to modality 1, the specimens are made with a load of 60 kN per specimen.

### Description of the Compounds Tested:

The compounds tested are as follows:

F1 Isopropyl laurate

F2 mixture of methyl laurate and methyl myristate having the following characteristics:
Vapour pressure: <0.55 Pa at 25° C.
Flash point in closed cup: 141° C.
Density at 20° C.: 867-870 g/cm³
Boiling interval: 261-295° C.

F3 Methyl cocoate

F4 Ethyl laurate

F5 Texanol® with the following characteristics:

Vapour pressure: 1.3 Pa at 25° C.

Flash point in closed cup: 122° C.

Density at 20° C.: 946 g/cm³

Boiling interval: 255-261° C.

### Example 1: Fluxed Binders for Surface Dressings

The following binders are prepared:

TABLE 1

| | | T0 | C1 | L1 | L2 | L3 | L4 | L5 |
|---|---|---|---|---|---|---|---|---|
| Bitumen | Supplier | ESSO | | | | | | |
| | Grade | 70/100 | | | | | | |
| Flux | Name | — | Pétrolier (1) | F1 | F2 | F3 | F4 | F5 |
| | Content (% by | 0 | 6.2 | 6 | 5.5 | 5.5 | 5.5 | 10 |
| | weight based | | | | | | | |
| | on the weight | | | | | | | |
| | of binder) | | | | | | | |
| Adhesive | Name | — | Impact 9000 (2) | | | | | |
| dope | Content (% by | 0 | 0.3 | 0.3 | 0.3 | 0.3 | 0.3 | 0 |
| | weight based | | | | | | | |
| | on the weight | | | | | | | |
| | of binder) | | | | | | | |

(1) Greenflux ® SD marketed by TOTAL
(2) Tallol fatty amides, N-[(dimethylamino)-3propyl] marketed by INGEVITY

Binder T0 is a non-flowable binder, which serves as a control for comparing the performance of the binder according to the invention to the binder without the addition of a compound according to the invention. Binder C1 is a fluxed binder with a volatile petroleum flux, which serves as a comparative example. Binders L1 and L2, L3, L4 and L5 are binders according to the invention.

The properties of the binders before/after stabilization and the adhesion results of the binders to the aggregates are shown in the following table:

TABLE 2

| | T0 | C1 | L1 | L2 | L3 | L4 | L5 |
|---|---|---|---|---|---|---|---|
| | Before stabilization | | | | | | |
| STV pseudo- | — | 440 | 429 | 450 | 481 | 484 | 341 |
| viscosity | | | | | | | |
| 40° C., | | | | | | | |
| 10 mm, s | | | | | | | |
| Penetrability | 85 | — | — | — | — | — | |
| at 25° C., | | | | | | | |
| 1/10 mm | | | | | | | |
| Ball-ring | 45.4 | — | — | | — | — | |
| temperature, | | | | | | | |
| ° C. | | | | | | | |
| | After stabilization | | | | | | |
| Loss of mass | — | 3.0% | 4.2% | 3.6% | 2.5% | 3.7% | |
| after | | | | | | | |
| stabilization | | | | | | | |
| Penetrability | — | 124 | 97 | 106 | 149 | 112 | |
| at 25° C., | | | | | | | |
| 1/10 mm | | | | | | | |
| Ball-ring | — | 43.0 | 44.6 | 44.6 | 41.0 | 43.6 | |
| temperature, | | | | | | | |
| ° C. | | | | | | | |

Adhesivity to the Vialit plate 5° C. + viadop PX10051 40 g/m²
La meilleraie 6/10 aggregates-washed dry

| | | | | | | |
|---|---|---|---|---|---|---|
| Fallen | — | 7 | 0 | 0 | 0 | 0 |
| unstained | | | | | | |
| Fallen | — | 39 | 22 | 17 | 24 | 7 |
| stained | | | | | | |
| Glued to | — | 54 | 78 | 83 | 76 | 93 |
| the plate | | | | | | |

The stabilization of fluxed bitumen is carried out according to the protocol described in the standard NF EN 13074 1.2 (April 2011). All tests are conducted according to the protocols described in the standards referenced and explained above. It can be seen that the binders according to the invention provide satisfactory results in terms of adhesivity and flowability (seen through the viscosity). In addition, the binders according to the invention regain their properties before fluxing, as seen through the penetrability and the ball-ring temperature. These results show that the binders according to the invention make it possible to obtain hard surface dressings in a short period of time, which allows a quick return to traffic.

Evaporation profiles (flux mass loss as a function of time) for binders C1, L1, L2, L3 and L4 without stabilization were measured. The evaporation profile of binder C2, having the same composition as binder C1 was also added, except that Greenflux® SD was replaced by Oleoflux®, a non-volatile non-petroleum flux. The results are reported in the following table:

TABLE 3

| binder | C2 | L1 | L2 | L3 | L4 | C1 |
|---|---|---|---|---|---|---|
| Sample mass (g) | 4.71 | 4.09 | 4.83 | 5.08 | 5.4 | 4.47 |
| Observations | | No odour | No odour | No odour | No odour | |
| time (mm) | Loss of mass (% flux) | | | | | |
| 0 | 0.0 | 0.0 | 0.0 | 0.0 | 0.0 | 0.0 |
| 1 | 2.4 | 1.2 | 1.1 | 1.5 | 1.3 | 1.5 |
| 2 | 3.7 | 2.0 | 1.8 | 1.5 | 1.6 | 1.8 |
| 5 | 7.9 | 3.7 | 4.5 | 3.3 | 3.6 | 2.1 |
| 10 | 13.1 | 7.0 | 7.1 | 5.6 | 6.4 | 2.6 |
| 22 | 20.5 | 11.3 | 12.7 | 9.6 | 11.8 | 2.6 |
| 30 | 24.7 | 15.8 | 16.5 | 12.5 | 16.2 | 2.9 |
| 60 | 37.7 | 26.8 | 26.7 | 20.4 | 26.5 | 3.2 |
| 90 | 44.5 | 35.8 | 32.7 | 27.3 | 34.7 | 5.5 |
| 127 | 51.8 | 42.3 | 38.4 | 31.8 | 41.5 | 7.6 |
| 181 | 60.6 | 47.7 | 43.6 | 36.2 | 47.1 | 10.2 |

It can be seen that in binders C1 and L1 to L4 the flux has volatilized but not in binder C2.

### Example 2: Bituminous Concrete Emulsion

Bituminous concrete emulsions are prepared according to the following formulas:

TABLE 4

| | BCE I1 | BCE I2 | BCE I3 | BCE C1 | BCE C2 | BCE C3 |
|---|---|---|---|---|---|---|
| Solid mineral | Uzerche 0/4 aggregates | | | | | |
| fraction | Pagnac 4/6.3 | | | | | |
| | Pagnac pre-lacquered 6/10 with 1.8 wt % emulsion | | | | | |
| Filler emulsion | 7.1 wt % | | | | | |
| Flux-content | 0.3 wt % | | | | | 0 |
| Flux-type | F1 | F2 | F3 | Oleoflux ® | Greenflux ® | |
| | | | | | SD | |
| Theoretical residual | 5.0 wt % | 5.0 wt % | 5.0 wt % | 5.3 wt % | 5.0 wt % | 5.0 wt % |
| anhydrous binder | | | | | | |
| content | | | | | | |

TABLE 5

| | BCE I4 | BCE I5 | BCE C4 | BCE C5 | BCE C6 |
|---|---|---|---|---|---|
| Solid mineral fraction | Dussac 0/2 + Dussac 2/6 + Dussac 6/10 | | | | |
| Filler emulsion | 7.7 wt % | | | | |
| Flux - content | 0.3 wt % | | | | 0 |
| Fluxing - type | F4 | F6 | Oleoflux ® | Greenflux ® | — |
| | | | | SD | |
| Theoretical residual | 5.0 wt % | 5.0 wt % | 5.3 wt % | 5.0 wt % | 5.0 wt % |
| anhydrous binder content | | | | | |

In these two tables:

“wt %” means “percentage by weight” based on the weight of the solid mineral fraction. The pre-lacquer or filler emulsion is in both cases a cationic emulsion. In both cases, bitumen emulsions are used which contain a 70/100 bitumen as binder. In both cases bitumen emulsions with a binder content of 65% by weight, based on the total weight of the emulsion, are used.

The flux is introduced by spraying at the end of mixing.

The compactability (GC), modulus, workability and compressive strength of these emulsion asphalt concretes are evaluated.

The results for the Uzerche-Pagnac formulas are given in the following tables:

TABLE 6

| | GC % voids as a function of the number of gyrations | | | | | | | | | | | | | |
|---|---|---|---|---|---|---|---|---|---|---|---|---|---|---|
| | 5 | 10 | 15 | 20 | 25 | 30 | 40 | 50 | 60 | 80 | 100 | 120 | 150 | 200 |
| BCE I1 | 24.2 | 20.9 | 19.1 | 17.8 | 17 | 16.2 | 15.1 | 14.3 | 13.6 | 12.6 | 11.8 | 11.2 | 10.5 | 9.6 |
| BCE I2 | 24.3 | 21 | 19.2 | 18 | 17.1 | 16.4 | 15.3 | 14.5 | 13.9 | 12.9 | 12.2 | 11.6 | 10.9 | 10 |
| BCE I3 | 23.9 | 20.8 | 19.1 | 17.9 | 17 | 16.3 | 15.2 | 14.3 | 13.7 | 12.7 | 11.9 | 11.3 | 10.6 | 9.8 |
| BCE C1 | 23.7 | 20.5 | 18.6 | 17.4 | 16.5 | 15.8 | 14.6 | 13.7 | 13.0 | 12.0 | 11.2 | 10.6 | 9.8 | 8.8 |
| BCE C2 | 24.1 | 21.2 | 19.1 | 17.9 | 17 | 16.3 | 15.2 | 14.3 | 13.7 | 12.6 | 11.9 | 11.3 | 10.6 | 9.7 |
| BCE C3 | 27.1 | 23.8 | 21.9 | 20.7 | 19.8 | 19.1 | 18 | 17.1 | 16.5 | 15.5 | 14.7 | 14.1 | 13.4 | 12.5 |

The compactability results demonstrate the ability of compound (I) to improve the compaction of emulsion asphalt concrete and to reduce void content compared with the same formula without fluxing (BCE C3).

TABLE 7

Modulus change (MPa)
10° C. 124 ms storage 35° C. 20% RH

| | 3 days | 7 days | 14 days | 21 days |
|---|---|---|---|---|
| BCE I2 | 614 | 547 | 689 | 656 |
| BCE I3 | 940 | 1127 | 1227 | 1322 |
| BCE C1 | 252 | 455 | 491 | 578 |
| BCE C2 | 820 | 1109 | 1313 | 1463 |
| BCE C3 | 2483 | 3168 | 3349 | 3472 |

Compound (I) allows a good increase in consistency of the bituminous concrete emulsion compared with the reference formula BCE Cl.

TABLE 8

| | Workability (N) at 4 hours |
|---|---|
| BCE I1 | 334 |
| BCE I2 | 253 |
| BCE I3 | 327 |
| BCE C1 | 272 |
| BCE C2 | 233 |
| BCE C3 | 187 |

Compound (I) maintains an acceptable workability value

TABLE 9

| | Compressive strength | | |
|---|---|---|---|
| | Duriez - modality 1 | | |
| | % voids | R (MPa) | r/R |
| BCE I1 | 9.3 | 2.22 | 0.79 |
| BCE I2 | 7.4 | 2.03 | 0.75 |
| BCE I3 | 8.1 | 2.49 | 0.94 |
| BCE C1 | 9.2 | 2.67 | 0.8 |
| BCE C2 | 8.8 | 2.64 | 0.84 |
| BCE C3 | 10.3 | 6.18 | 0.89 |

Compound (I) maintains an acceptable value of compressive strength. The void content is similar to the measured value for the reference formulae Cl and C2 and lower than the measured value for the flux free formula C3.

The results for the Dussac formulas are given in the following tables:

TABLE 10
GC % voids as a function of the number of gyrations

| | 5 | 10 | 15 | 20 | 25 | 30 | 40 | 50 | 60 | 80 | 100 | 120 | 150 | 200 |
|---|---|---|---|---|---|---|---|---|---|---|---|---|---|---|
| BCE I4 | 26.1 | 23.1 | 21.5 | 20.3 | 19.5 | 18.9 | 17.9 | 17.2 | 16.6 | 15.7 | 15.1 | 14.6 | 14.0 | 13.3 |
| BCE I5 | 25.9 | 23.0 | 21.3 | 20.3 | 19.4 | 18.8 | 17.8 | 17.1 | 16.6 | 15.8 | 15.2 | 14.7 | 14.2 | 13.6 |
| BCE C4 | 25.9 | 22.8 | 21.1 | 20.0 | 19.1 | 18.4 | 17.5 | 16.7 | 16.1 | 15.3 | 14.6 | 14.1 | 13.6 | 12.9 |
| BCE C5 | 26.3 | 23.5 | 21.8 | 20.8 | 19.9 | 19.3 | 18.4 | 17.7 | 17.1 | 16.3 | 15.7 | 15.2 | 14.6 | 14.0 |
| BCE C6 | 27.6 | 24.7 | 23.1 | 21.9 | 21.1 | 20.5 | 19.4 | 18.7 | 18.1 | 17.3 | 16.6 | 16.1 | 15.5 | 14.8 |

The compactability results demonstrate the ability of compound (I) to improve the compaction of the bitumen concrete emulsion and to reduce void content compared with the same formula without flux (BCE C6).

TABLE 11

| | Workability (N) at 4 hours |
|---|---|
| BCE I4 | 240 |
| BCE I5 | 310 |
| BCE C4 | 241 |
| BCE C5 | 406 |
| BCE C6 | 641 |

Compound (I) improves the workability of bituminous concrete emulsion compared with the reference solutions.

TABLE 12

| | | 10° C. 124 ms storage |
|---|---|---|
| | Module change (MPa) | 35° C. 20% RH |
| | 3 days | 7 days |
| BCE I5 | 758 | 1274 |
| BCE C4 | 644 | 836 |

Compound (I) allows a good rise in consistency of the bituminous concrete emulsion compared with the reference formula BCE C4.

TABLE 13

| | Compressive strength | | |
|---|---|---|---|
| | Duriez - modality 1 | | |
| | % voids | R | r/R |
| BCE I4 | 9.7 | 1.94 | 0.92 |
| BCE I5 | 9.5 | 2.24 | 0.91 |
| BCE C4 | 10.1 | 2.44 | 0.89 |

Compound (I) is used to maintain an acceptable value of compressive strength. The void content is similar to the measured value for the reference formula C4.

1. Method for preparing a bituminous product comprising contacting solid mineral particles, a composition comprising a hydrocarbon binder and a compound of formula (I) or a mixture comprising at least one such compound of formula (I)
R¹—C(O)O—R² (I)
where:
each of R¹ and R², which may be identical or different, is a linear or branched hydrocarbon chain which does not carry an unsaturated covalent bond, optionally interrupted by one or more oxygen atoms, and optionally carrying one or more hydroxyl functions
provided that, in the case of a mixture additionally comprising one or more unsaturated compounds of formula (II)
R—C(O)—O—R′ (II)
where:
each of R and R′, identical or different, is a linear or branched unsaturated hydrocarbon chain comprising at least one C═C double bond,
the mass ratio (II)/(I+II), defined as the ratio of the total mass of the unsaturated compounds of formula (II) to the sum of the total mass of the compounds of formula (I) and the total mass of the unsaturated compounds of formula (II), is less than 15% by mass, preferably less than 10% by mass.

2. Method according to claim 1, wherein the bituminous product is a surface dressing.

3. Method according to claim 1, wherein the hydrocarbon binder is used in the form of an anhydrous binder and comprises, based on the total weight of binder, from 3% to 18% by weight of said compound of formula (I).

4. Method according to claim 2, wherein the hydrocarbon binder is a binder emulsion and comprises, based on the total weight of the hydrocarbon binder, 0.1 to 10% by weight of said compound of formula (I).

5. Method according to claim 1, wherein the bituminous product is a bituminous concrete emulsion.

6. Method according to claim 5, wherein the hydrocarbon binder comprises 1 to 25% by weight of said compound of formula (I), based on the total weight of the hydrocarbon binder.

7. Method according to claim 1, wherein the bituminous product is a cold-mix bituminous material.

8. Method according to claim 7, wherein the hydrocarbon binder comprises, based on the total weight of the hydrocarbon binder, 0.1 to 6% by weight of said compound of formula (I).

9. Method according to claim 1, wherein the bituminous product is a hot-mix or warm-mix asphalt.

10. Method according to claim 9, wherein the hydrocarbon binder comprises 1 to 30% by weight of said compound of formula (I), based on the total weight of the hydrocarbon binder.

11. Method according to claim 1, wherein the bituminous product is a storable asphalt.

12. Method according to claim 1, wherein the compound of formula (I) has a molecular weight of 140 g/mol to 270 g/mol.
